(19) United States
(12) Patent Application Publication
(10) Pub. No.: US 2018/0099720 A1
(43) Pub. Date: Apr. 12, 2018

(54) PERSONAL TRANSPORTATION DEVICE WITH MULTIPLE AIR CHAMBER WHEEL STRUCTURE

(71) Applicant: Shane Chen, Camas, WA (US)

(72) Inventor: Shane Chen, Camas, WA (US)

(21) Appl. No.: 15/289,191

(22) Filed: Oct. 9, 2016

(51) Int. Cl. B62K 11/00; B62K 1/00; B60C 29/00; B60C 5/22

(52) U.S. Cl. CPC B62K 11/007; B62K 1/00; B60C 2200/10; B60C 5/22; B60C 29/007

(57) ABSTRACT

A fore-aft self-balancing personal transportation device having a single wheel structure with multiple air chambers and air pressure equalization between the air chambers. Embodiments include dual tires on a single rim structure, or a single tire structure with multiple lobes, etc. Air passage between the air chambers may be internal through the rim or external via an air hose or related structure. The air chambers may be tubed or tubeless. Several different embodiments are disclosed.

### CROSS REFERENCE TO RELATED APPLICATIONS

This application claims the benefit of earlier filed U.S. provisional application No. 62/373,967, filed Aug. 11, 2016, entitled Ergonomic, Central-Wheel Structure Self-Balancing Device by the inventor above.

### FIELD OF THE INVENTION

The present invention relates to centered-wheel structure fore-aft self-balancing transportation devices and, more specifically, to such devices that have a dual air chamber wheel structure with pressure equalization between the air chambers to improve turning, stability, shock absorption and/or performance.

### BACKGROUND OF THE INVENTION

The prior art includes the Solowheel marketed by Inventist and described in U.S. Pat. No. 8,807,250, entitled Powered Single-Wheeled Self-Balancing Vehicle for Standing User and issued to Shane Chen, the inventor herein. This patent describes a single wheel or single wheel structure personal transportation device that achieves fore-aft self-balancing. The present invention may be applied to transportation devices of the type described in the '250 patent and other devices.

The prior art also includes a device similar to that shown in FIG. 1 of the '250 patent, yet with two separate tires mounted on the wheel rim. The two tires may improve side-to-side balance, yet there is no air pressure equalization between the two tires. Several disadvantageous aspects arise from this arrangement. A first is that if the air pressure in the two tires is different (as is often the case due to unequal inflation or different air-loss diffusion rates), then the device will not go in a straight line, instead curving towards the tire with lower air pressure (i.e., smaller radius). A second is that during a turn, the outside tire may lift off the ground, switching the device from a two tire on the ground more stable position to a one tire on the ground less stable position.

A third disadvantageous aspect of the non-pressure equalized two tire embodiment is that with only one wheel on the ground during a turn, the effectiveness of turning is limited to the radius of that one tire, the same way turning is achieved with the single tire device of FIG. 1 of the U.S. Pat. No. 8,807,250. The present invention permits air to pass between the two tires (or air chambers), so that the tire subjected to more weight (as a rider leans into a turn) is reduced in size compared to the tire bearing less weight. This differential in tire size creates two different radius lengths and thus aids in turning while also improving stability.

Yet a fourth disadvantageous aspect is that if there is an obstacle in a pathway that hits only one tire, the device is more likely to be knocked off balance than if there is air pressure equalization between the tires and thus the shock is absorbed in part by both tires.

Other two-tire devices exist that are not in the field of fore-aft self-balancing personal transportation devices. These include tire arrangements for tractor-trailer or “over-the-road” trucks. These arrangements are for load bearing, non-steering tires and may include devices that equalize pressure between those tires, detect leaks, equalize pressure if above a threshold, and other functions. Devices of this type are disclosed in U.S. Pat. No. 5,771,834 to Hsiao, U.S. Pat. No. 5,560,792 to Anthony, U.S. Pat. No. 5,495,880 to Yasushi, and U.S. Pat. No. 5,307,846 to Heinemann.

### SUMMARY OF THE INVENTION

Accordingly, it is an object of the present invention to provide a personal transportation device having a dual (or multiple) air chamber wheel structure and pressure equalization between the air chambers.

It is also an object of the present invention to provide such a dual (or multiple) air chamber wheel structure that may be readily and cost-effectively manufactured and/or readily mounted and replaced by a user.

It is yet another object of the present invention to provide a dual air (or multiple) chamber wheel structure for a personal transportation device that improves turning, shock absorption, stability and/or performance.

These and related objects of the present invention are achieved by use of a personal transportation device with turn-aiding multiple air chamber wheel structure as described herein.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIG. 1 is perspective view of one embodiment of a dual air chamber personal transportation device in accordance with the present invention.

FIG. 2 is perspective view of another embodiment of a dual air chamber personal transportation device in accordance with the present invention.

FIG. 3 is perspective view of yet another embodiment of a dual air chamber personal transportation device in accordance with the present invention.

FIG. 4 is a cross-sectional view illustrating a portion of one embodiment of a wheel structure and a rim structure for use in the devices of FIGS. 1-3 in accordance with the present invention.

FIGS. 5-6 are cross-sectional views illustrating other embodiments of a wheel structure and a rim structure in accordance with the present invention.

FIGS. 7-8 are cross-sectional views illustrating embodiments of a wheel structure having air chamber “lobes” in accordance with the present invention.

### DETAILED DESCRIPTION

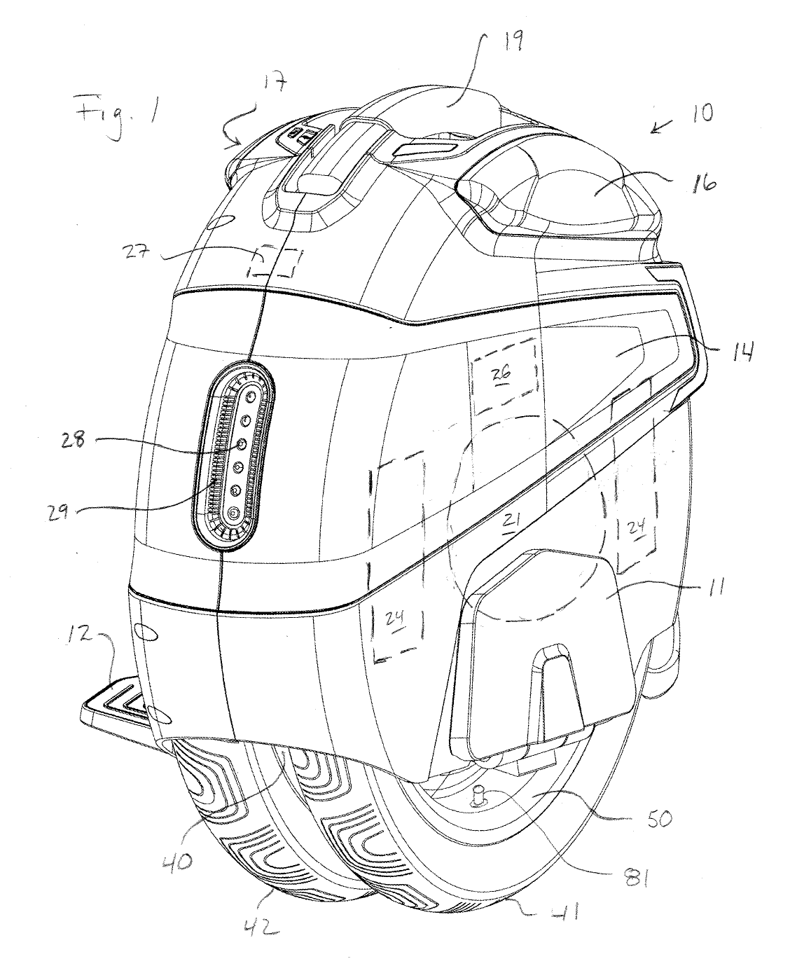

Referring to FIG. 1, a perspective view of a personal transportation device 10 having a dual air chamber wheel structure 30 in accordance with the present invention is shown. This dual (or more) air chamber tire structure 30 may also be referred to herein as wheel structure 30.

Device 10 is preferably fore-aft balancing and self-propelled and may operate in a manner similar to that disclosed in U.S. Pat. No. 8,807,250 and U.S. patent application Ser. No. 14/811,702, filed Jul. 28, 2015, and entitled Fore-Aft Self-Balancing Transportation Device With Low and Centered Foot Platform by Shane Chen. Both U.S. Pat. No. 8,807,250 and U.S. patent application Ser. No. 14/811,702 are hereby incorporated by reference as though included in their entirety herein.

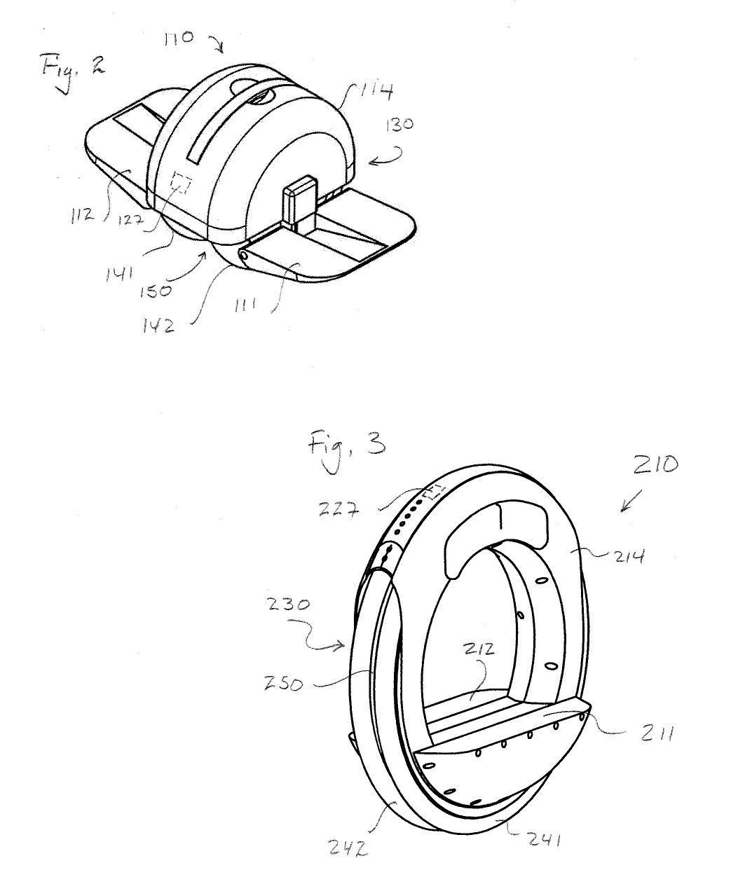

Device 10 (and devices 110,210 of FIGS. 2 and 3) add the use of a dual (or multiple) air chamber wheel structure with an interconnecting airway. This structure allows air to move from one chamber to the other as weight or pressure on one air chamber increases or decreases relative to the other, for example, as a rider shifts weight from side to side or when one tire hits a bump that the other tire does not encounter.

Device 10 (and others herein) preferably has what may be referred to as a “single wheel structure.” This means that while there may be two (or more) tires, those tires have a single axis of rotation and are coupled to a rim structure such that movement of one tire causes movement of the other. The tires are preferably placed in parallel and adjacent one another. In some aspects, the paired adjacent tires may approximate a single wide tire.

The embodiment of FIG. 1 illustrates device 10 with two tires 41,42, each enclosing an air chamber 47,48, respectively (are chambers are shown in cross-sectional in FIGS. 4-8). These tires are mounted on a rim structure 50 that receives the tires and holds them such that they move together. The rim structure may take the form of two conventional rims joined together or a broader singular rim that supports both tires, or be otherwise formed. Rim structure 50 is shown in more detail in other figures.

The tires and their air chambers are arranged substantially parallel to one another and equally spaced from the principal vertical plane of device 10. With this arrangement, a rider may more efficiently and effectively execute a turn. As a rider shifts his/her weight to one side, say to the right, weight on the right air chamber increases while weight on the left air chamber decreases. This causes air to be pushed out of the right tire and into the left tire, decreasing the size of the right tire and increasing the size of the left tire, thus giving the right tire a smaller radius than the left tire. This difference in radius causes the device to turn to the right. It also keeps both tires on the ground longer which increases the stability of the device.

Device 10 of FIG. 1 may include two foot platforms 11,12 (11 folded to a closed or stowage position, and 12 extended for use) located on opposite sides of wheel structure 30. The wheel structure may be covered in part by housing 14, and a pair of leg contact surfaces 16,17 may be provided on the housing each above its respective foot platform section 11,12. Leg contact surfaces are not required to operate device 10 but may aid in comfort and more precise control (due to enhanced friction).

Device 10 may include a drive motor 21, battery 24, electronic control circuitry 26 (hereinafter often referred to as “electronic control”), and a gyroscopic position sensor 27. Drive motor 21 may be a hub motor or other suitable motor. The battery and electronic control may be provided in any suitable manner within the housing. The gyroscopic position sensor 27 is preferably positioned toward the top of the device.

Electronic control 26 may generate control signals for motor 21 (e.g., speed and direction) based on fore-aft lean and side-to-side tilt data as detected by sensor 27. The drive motor, battery, electronic control and position sensor, and their mounting and operation, are known in the art. Various arrangements, configurations and operation of these components may be implemented in transportation device 10 or other transportation devices herein without departing from the present invention. It should be recognized that motor 21, battery 24, electronic control 26 and sensor 27 may be elsewhere located in device 10.

Device 10 may also include indicator lights 28 for indicating status and pathway lighting 29, a handle 19, and at least a first valve stem 81.

Referring to FIG. 2, a perspective view of another embodiment of a personal transportation device 110 having a dual air chamber wheel structure 130 in accordance with the present invention is shown. Device 110 is similar to device 10 in that it has two platforms 111,112, two tires 141,142 mounted on a single rim structure 150, a housing 114, a position sensor 127, and drive, control and power elements similar to those described with respect to device 10. Device 110 has a more compact or miniature shape compared to device 10.

Referring to FIG. 3, a perspective view of yet another embodiment of a personal transportation device 210 having a dual air chamber wheel structure 230 in accordance with the present invention is shown. Device 210 is similar to device 10 in that it has platform sections 211,212 (though the platform sections may be continuous in device 210), two tires 241,242 mounted on a single rim structure 250, a housing 214, a position sensor 227, and drive, control and power elements. In device 210, the drive motor may directly engage the rim, and the motor, battery and/or control circuitry may be provided below the platforms 211,212.

The devices 10,110,210 of FIGS. 1-3 are seatless and include foot platforms. The platforms are preferably large enough longitudinally to receive pressure (i.e., weight shifts) from the ball and heal of a user's foot. These devices are thus examples of “foot-controlled” devices because control comes largely from the user bending at the ankle joint and applying weight to the ball or heal of one or more feet to affect fore-aft driving of the device.

It should be noted that the multiple air chamber air pressure equalization of the present invention is also applicable to personal transportation devices that have a seat structure and/or those that have foot supports such as bars or pedals or the like that are less extensive than a foot platform.

Referring to FIG. 4, a cross-sectional view illustrating a portion of one embodiment of wheel structure 30 and rim structure 50 is shown. Rim structure 50 preferably includes an annular rim 54 that may have two pairs 51,52 of flanges, each pair receiving a tire 41,42, respectively. A wheel disk or internal frame 55 is provided within rim 54 and preferably couples rim 54 to other components of device 10 (i.e., drive motor 21, etc.).

FIG. 4 illustrates a channel 62 formed in rim structure 50 that passes air from one tire to the other, e.g., from one air chamber 47 to the other 48, and vice versa. In this embodiment, tires 41,42 form an air tight seal with rim 54 and air can freely pass through conduit 62. While one conduit is shown in FIG. 4, and of a given size, more than one conduit may be provided, for example, there may be many distributed around the rim (e.g., 4, 8, 12, or more) to aide in efficient air transfer, and they may be larger to facilitate reduce air flow.

FIG. 4 also illustrates a valve stem 81 for tire 41. A valve stem 82 (shown in phantom lines because it is optional) may be provided for tire 42. Further, a cut-off plug or switch 96 may be provided in rim 50 and configured to releasably block conduit 62, for example, so that each tire could be inflated separately and checked for leaks, etc.

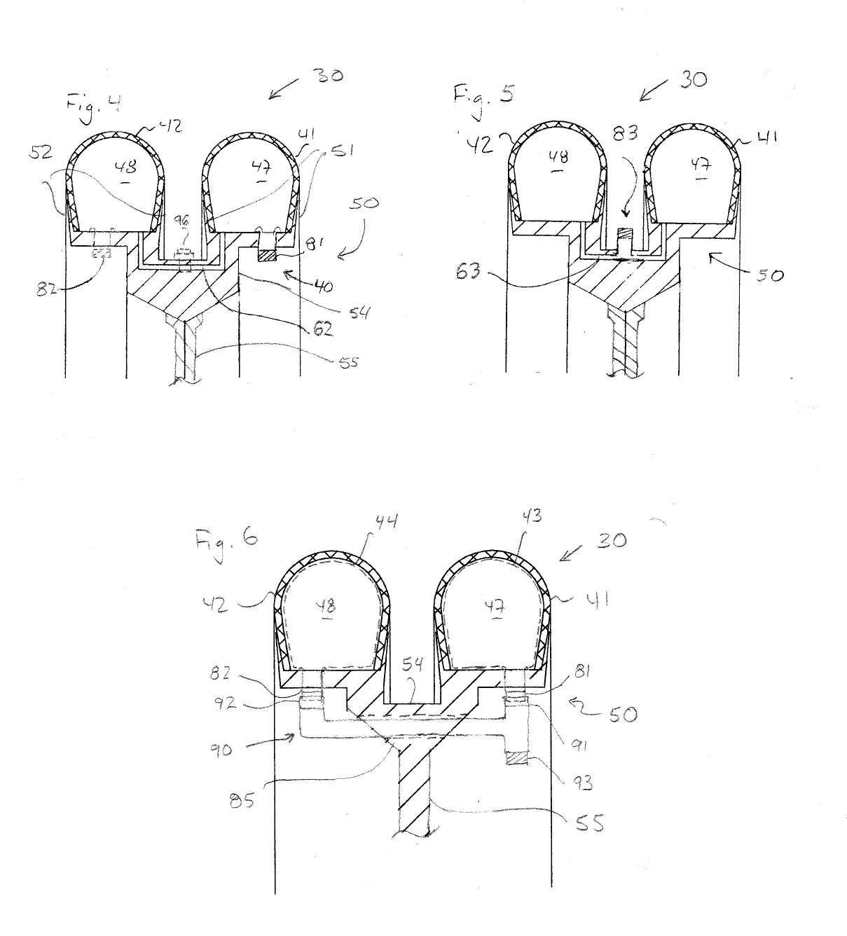

Referring to FIG. 5, a similar yet different arrangement from that of FIG. 4 is shown. In FIG. 5, the valve stem 83 is not placed in the rim extension that supports the tire, but rather centrally between tires 41,42. Valve stem 83 is coupled through rim structure 50 to an internal air conduit 63 that provides air passage between the tires, and between the valve stem 83 and the tires 41,42.

Among other features, this embodiment presents a single structure that provides both air chamber inflation and equalization between the air chambers.

Referring to FIG. 6, a cross-sectional view of another embodiment of wheel structure 30 and rim structure is shown. In FIG. 6, rim structure 50 includes an opening or channel 85 through rim 54 and/or wheel disc 55 for passage of an external air conduit 90. Air conduit 90 may have valve couplers 91,92 that releaseably couple to valve stems 81,82, respectively, and allow air flow therebetween. The valve couplers may be screw-on, pressure fit or otherwise configured. Air conduit 90 may also include its own valve stem 93 though which air may be inserted into (or released from) the conduit and thereby the tires 41,42 and their air chambers.

It should be noted that the embodiment of FIG. 6 works with tubeless or tubed tires. Inner tubes 43,44 are shown in phantom lines within tires 41,42, respectively, for tube based operation.

It should be noted that air conduit 90 permits retrofitting of an existing dual-tire, single wheel structure device to achieve tire pressure equalization. If need be, a hole or channel (opening 85) could be drilled in the rim 54 or disk 55 and air conduit 90 inserted therethrough and coupled on to valve stems 81,82. Releasable valve couplers 91,92 are known in the art.

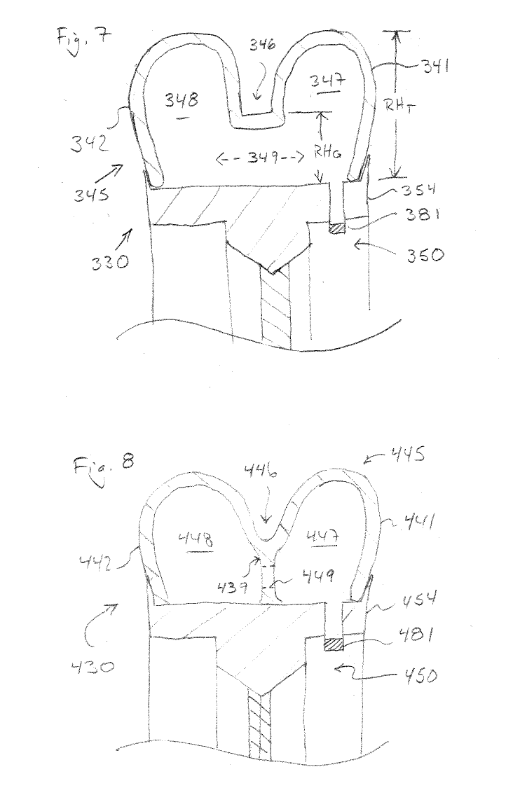

Referring to FIG. 7, a partial cross-sectional view of another embodiment of a dual air chamber wheel structure 330 for use with the personal transportation devices 10,110,210 of FIGS. 1-3 in accordance with the present invention is shown. Wheel structure 330 includes a single tire 345 yet with two lobes 341,342 (which approximate tires 41,42 of device 10) and a deep, relatively-broad groove 346 between the lobes. The circumferential groove or depression 346 may descend towards rim structure 350 a third or half or two-thirds or more of the radial height of tire 345 (RH_{T}) above rim structure 350 (excluding the flanges). In the embodiment of FIG. 7, the radial height of groove 346 (RH_{G}) appears to be at or a little less than half of RH_{T}, the height of the tire above the rim.

The depth and configuration of groove 346 may vary without departing from the present invention and may give the impression that there are two independent tires on rim structure 350, when there is actually only one tire. The performance will be similar to a two tire performance particularly as the groove depth increases, i.e., as the lobes approach individual tires. The similarities in performance will include (a) the feel of two side-by-side tires which facilitates lateral balance and (b) one tire (or lobe) decreasing in radius under added weight (relative to the other) such that turning and stability are improved as discussed herein.

FIG. 7 also illustrates air chamber 347,348, defined by the lobes, and an air pass opening 349 therebetween. The air passage opening is the space between annular depression 346 and rim 354. Tire 345 may be inflated via a valve stem 381 extending through rim structure 350.

FIG. 8 illustrates another embodiment of a dual air chamber wheel structure 430 in accordance with the present invention. Wheel structure 430 is similar to structure 330 of FIG. 7 yet with a groove 446 that may be narrower and the provision of an internal support wall 439 between the air chambers 447,448. One or more openings 449 are provided within the support wall for air passage. These openings or air conduits 449 may be distributed along the support wall. In one embodiment, 4 to 12 evenly spaced openings 449 are provided. A valve stem 481 for inflating tire structure 445 is shown extending through rim structure 450.

It should be recognized that tire structure and rim structure embodiments of FIGS. 4-8 may be used on any of the dual air chamber transportation devices 10,110,210 shown in FIGS. 1-3 and others.

It should also be recognized that the dual (or multiple) air chamber tire structure disclosed herein achieves several benefits. One is that with the tire pressure equalized, the tires or lobes will be inflated to the same degree and thus the tires or lobes will have the same radius, causing the device to travel straight forward when a rider places equal weight on both platforms. Another is that turning effectiveness is improved as discussed above. Yet another is that stability is improved as the two tires or lobes will retain contain with the ground longer than a two separate tire arrangement. In addition, the pressure equalization improves shock absorption as shocks are distributed over a greater air volume. These and other benefits are achieved by the present invention.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A personal transportation device, comprising:
a single wheel structure having a rim structure and first and second air chamber defining members, respectively defining first and second air chambers, mounted to the rim structure;
first and second foot supports provided on opposite sides of the wheel structure;
a drive motor that drives the wheel structure;
a positioning sensor that determines fore-aft position; and
electronic control circuitry that causes the drive motor to drive the wheel structure towards fore-aft self-balancing based on position data from the position sensor;
wherein the device is configured such that air passes between the first air chamber and the second air chamber.

2. The device of claim 1, wherein the first and second air chamber defining members are a first and a second tire, respectively.

3. The device of claim 2, wherein the rim structure supports the first and second tires such that movement of one tire causes movement of the other.

4. The device of claim 1, wherein the rim structure defines an air conduit within the rim structure that connects the first air chamber to the second air chamber is such a way that air flows between the first and second air chambers.

5. The device of claim 4, wherein the rim structure defines a plurality of air conduits within and distributed about the rim structure that connect the first air chamber to the second air chamber is such a way that air flows between the first and second air chambers through the plurality of air conduits.

6. The device of claim 1, wherein air passage between the first and the second air chambers is achieved at least in part with an external air conduit.

7. The device of claim 1, including a tire structure that includes a first and a second tire lobe and an annular depression between and defining the two lobes, the annular depression having a height from the rim structure that is two-thirds or less the height of the tire lobes from the rim structure, and wherein the first and second lobes are respectively the first and second air chamber defining members.

8. The device of claim 7, wherein the annular depression has a height above the rim structure that is half or less the height of the tire lobes above the rim structure.

9. The device of claim 7, further comprising a sidewall between the annular depression and the rim structure.

10. The device of claim 2, wherein, in lateral cross-section and away from the rim structure, the first and second tires have curved corners.

11. The device of claim 1, further including at least a first inner tube within the first air chamber defining member.

12. The device of claim 1, wherein the first and second foot supports are a first and a second foot platform, respectively.

13. A personal transportation device, comprising:
a single wheel structure having a rim structure and a first tire and a second tire mounted on the rim structure, the first and second tires respectively defining first and second air chambers;
first and second foot platforms provided on opposite sides of the wheel structure;
a drive motor that drives the wheel structure;
a position sensor that determines fore-aft position;
electronic control circuitry that causes the drive motor to drive the wheel structure towards fore-aft self-balancing based on position data from the position sensor; and
an air passage conduit that achieves air passage between the first air chamber and the second air chamber.

14. The device of claim 13, wherein the air passage conduit is configured in the rim structure.

15. The device of claim 13, further comprising a plurality of air passage conduits that each achieve air passage between the first air chamber and the second air chamber.

16. The device of claim 13, wherein the air passage conduit is an external air passage conduit.

17. A personal transportation device, comprising:
a wheel structure having a rim structure and first and second air chamber defining members coupled to the rim structure, the first air chamber defining member defining, at least in part, a first air chamber and the second air chamber defining member defining, at least in part, a second air chamber; and
a first foot support and a second foot support provided on opposite sides of the wheel structure;
wherein the device is configured such that during use air passes between the first air chamber and the second air chamber.

18. The device of claim 17, wherein air passage is achieved at least in part through an air passage conduit provided within the rim structure between the first and second air chambers.

19. The device of claim 17, wherein air passage is achieved at least in part through an external air passage conduit between the first and second air chambers.

20. The device of claim 17, comprising a plurality of air passage conduits that each achieve air passage between the first air chamber and the second air chamber.

21. The device of claim 17, wherein the first and second air chamber defining members include a tire structure with a first and a second tire lobe and an annular depression between and defining the two lobes, the annular depression having a height from the rim structure that is two-thirds or less the height of the tire lobes from the rim structure, and wherein the first and second lobes are respectively the first and second air chamber defining members.

22. The device of claim 17, wherein the first and second foot supports are a first and a second foot platform, respectively.
